(19) United States
(12) Patent Application Publication
(10) Pub. No.: US 2026/0139578 A1
(43) Pub. Date: May 21, 2026

(54) Thermochromic-Based Estimation Of Solid Accumulation Level In Well Fluid Separators

(71) Applicant: Chevron U.S.A. Inc., San Ramon, CA (US)

(72) Inventors: Jace Elliott Donaldson, Loveland, CO (US); Scott Eric Weatherwax, Timnath, CO (US)

(21) Appl. No.: 18/951,359

(22) Filed: Nov. 18, 2024

(51) Int. Cl. E21B 43/34; G01F 23/22; G01K 11/12

(52) U.S. Cl. CPC E21B 43/35; G01F 23/22; G01K 11/12

(57) ABSTRACT

A fluid separator with solid level indicator includes a container having a cavity. The container includes a fluid inlet and multiple fluid outlets. The fluid separator further includes a fire tube extending into the cavity to dissipate heat into the cavity. The fluid separator also includes a thermochromic indicator that is on the outside of the container, where the thermochromic indicator covers at least a portion of the container. A color of the thermochromic indicator depends on a temperature of the container at a location of the thermochromic indicator on the outside of the container. The temperature of the container at the location of the thermochromic indicator depends on whether the container contains solid at an inside location that is at least partially aligned with the location of the thermochromic indicator.

### TECHNICAL FIELD

The present application is related to estimating solid level in fluid separators used in oil and gas production and, more particularly, to thermochromic-based estimation of solid level in multiphase fluid separators.

### BACKGROUND

Fluid separators are generally used in oilfield processing to perform multiphase fluid separation functions. For example, a separator may be used to separate produced fluid, which is a multiphase fluid, into oil, water, and gas. A separator may include a firetube that extends into the cavity of the separator. The fire tube may be used to provide heat to the contents of the separator such as the multiphase fluid to aid in the separation of multiphase fluid within the separator. The incoming multiphase fluid may also include solid, such as sand, paraffins, iron sulfide, rock, wax, and/or other material(s), that can accumulate in the separator over time. If excess solid builds up in the separator, the fire tube may be unable to dissipate enough heat due to the insulative characteristics of solid. The solid can also insulate and prevent chemical treatments that kill bacteria that eat metal. In such cases, the fire tube may become damaged, which can result in loss of the barrier between the fire within the fire tube and the multiphase fluid. Although sophisticated equipment such as thermal cameras can be used to detect solid levels in separators, the use of such equipment can be expensive and generally requires a specialized crew. Thus, a temperature-based solution that enables reliable visual estimation of the level of solid in separators may be desirable.

### SUMMARY

The present application is related to estimating solid level in fluid separators used in oil and gas production and, more particularly, to thermochromic-based estimation of solid level in multiphase fluid separators. In an example embodiment, a fluid separator with solid level indicator includes a container having a cavity. The container includes a fluid inlet and multiple fluid outlets. The fluid separator further includes a fire tube extending into the cavity to dissipate heat into the cavity. The fluid separator also includes a thermochromic indicator that is on the outside of the container, where the thermochromic indicator covers at least a portion of the container. A color of the thermochromic indicator depends on a temperature of the container at a location of the thermochromic indicator on the outside of the container. The temperature of the container at the location of the thermochromic indicator depends on whether the container contains solid at an inside location that is at least partially aligned with the location of the thermochromic indicator.

In another example embodiment, a method for non-invasively estimating solid level in a fluid separator includes providing a container of a fluid separator having a cavity, a fluid inlet, and multiple outlets, where a fire tube extends into the cavity to dissipate heat into the cavity. The method further includes providing a thermochromic indicator. The method also includes covering a portion of the container with the thermochromic indicator on outside of the container. The color of the thermochromic indicator depends on a temperature of the container at a location of the thermochromic indicator on the outside of the container. The temperature of the container at the location of the thermochromic indicator depends on whether the container contains solid at an inside location that is at least partially aligned with the location of the thermochromic indicator. The method further includes inspecting visually the color of the thermochromic indicator to estimate a level of the solid in the container.

These and other aspects, objects, features, and embodiments will be apparent from the following description and the appended claims.

### BRIEF DESCRIPTION OF THE DRAWINGS

Reference will now be made to the accompanying drawings, which are not necessarily drawn to scale, and wherein:

FIG. 1A illustrates a horizontal fluid separator with a temperature strip for estimating solid level in the horizontal fluid separator according to an example embodiment;

FIG. 1B illustrates a closeup view of a portion of the horizontal fluid separator of FIG. 1A including the temperature strip according to an example embodiment;

FIG. 2 illustrates a horizontal fluid separator with temperature strips for estimating solid level in the horizontal fluid separator according to another example embodiment;

FIG. 3 illustrates a horizontal fluid separator with a temperature strip for estimating solid level in the horizontal fluid separator according to another example embodiment;

FIG. 4 illustrates a horizontal fluid separator with temperature strips for estimating solid level in the horizontal fluid separator according to another example embodiment;

FIG. 5 illustrates a horizontal fluid separator with temperature strips for estimating solid level in the horizontal fluid separator according to another example embodiment;

FIG. 6 illustrates a horizontal fluid separator with a temperature strip for estimating solid level in the horizontal fluid separator according to another example embodiment;

FIG. 7 illustrates the horizontal fluid separator with the temperature strip of FIG. 6 and a different solid level in the horizontal fluid separator according to an example embodiment;

FIG. 8 illustrates the horizontal fluid separator with the temperature strip of FIG. 6 for estimating solid level in the horizontal fluid separator according to another example embodiment;

FIG. 9 illustrates a horizontal fluid separator with a temperature strip for estimating solid level in the horizontal fluid separator according to another example embodiment;

FIG. 10 illustrates a horizontal fluid separator with thermochromic paint for estimating solid level in the horizontal fluid separator according to an example embodiment;

FIG. 11 illustrates the horizontal fluid separator with the thermochromic paint of FIG. 10 indicating solid level in the horizontal fluid separator according to an example embodiment;

FIG. 12 illustrates a horizontal fluid separator with thermochromic paint for estimating solid level in the horizontal fluid separator according to another example embodiment;

FIG. 13 illustrates a horizontal fluid separator with thermochromic paint stripes for estimating solid level in the horizontal fluid separator according to another example embodiment;

FIG. 14 illustrates a vertical fluid separator with a temperature strip for estimating solid level in the vertical fluid separator according to an example embodiment;

FIG. 15 illustrates a vertical fluid separator with thermochromic paint for estimating solid level in the vertical fluid separator according to another example embodiment; and

FIG. 16 illustrates a method for non-invasively estimating solid level in a fluid separator according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding but not necessarily identical elements.

### DETAILED DESCRIPTION

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of systems and methods described herein. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

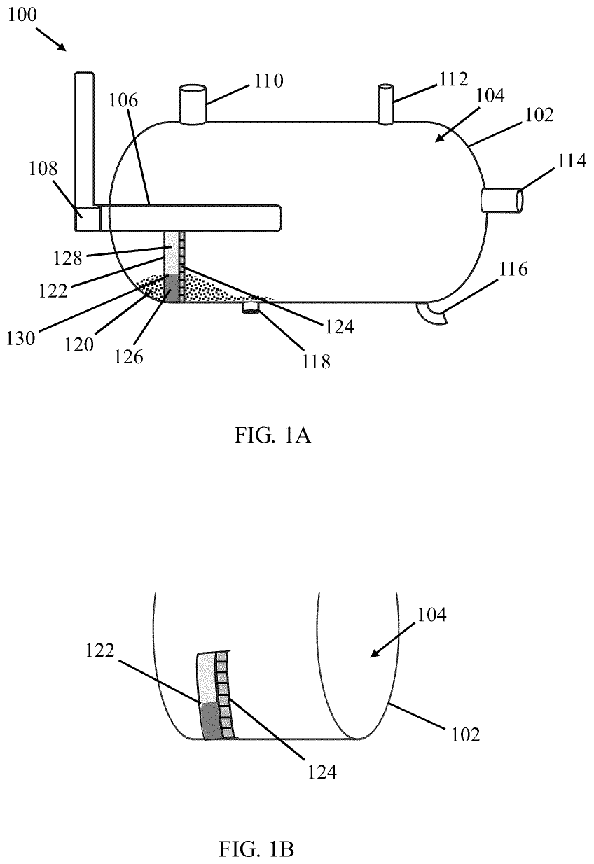

FIG. 1A illustrates a horizontal fluid separator 100 with a temperature strip 122 for estimating solid level in the horizontal fluid separator 100 according to an example embodiment, and FIG. 1B illustrates a closeup view of a portion of the horizontal fluid separator 100 of FIG. 1A including the temperature strip 122 according to an example embodiment. In some example embodiments, the horizontal fluid separator 100 includes a container 102 having a cavity 104. In FIG. 1A, the container 102 is shown as transparent and some components of the separator 100, such as a diverter plate, are omitted for clarity of illustration.

Referring to FIGS. 1A and 1B, in some example embodiments, the container 102 includes a fluid inlet 110 and multiple outlets including a gas outlet 112, an oil outlet 114, and a water outlet 116. A multiphase fluid (e.g., crude oil) may be provided into the cavity 104 via the fluid inlet 110. After separation of the multiphase fluid by the fluid separator 100, gas may exit the cavity 104 through the gas outlet 112, oil may exit the cavity 104 through the oil outlet 114, and water may exit the cavity 104 through the water outlet 116. The container 102 may also include a solid drain 118 for removing solid 120, such as sand, paraffins, iron sulfide, rock, wax, and/or other material(s), from the cavity 104 of the container 102.

In some example embodiments, the fluid separator 100 includes a fire tube 106 that extends into the cavity 104 of the container 102. For example, a heat source 108 may direct heat into the fire tube 106, and the fire tube 106 may dissipate the heat into the cavity 104. The heat dissipated by the fire tube 106 may help facilitate the separation of the multiphase fluid. To avoid damage to the fire tube 106, the solid 120 may be removed from the cavity 104 before the solid 120 accumulates and reaches the fire tube 106, where the solid 120 may interfere with the dissipation of heat by the fire tube 106.

In some example embodiments, the fluid separator 100 includes a thermochromic indicator that is on the outside of the container. Thermochromic indicator may cover at least a portion of the container 102. The color of the thermochromic indicator depends on a temperature of the container 102 at a location of the thermochromic indicator on the container 102. Because the solid 120 can affect the temperature of the container 102 at locations of the solid 120 inside the cavity 104, the temperature of the container 102 at the location of the thermochromic indicator depends on whether the container 102 contains the solid 120 at an inside location that is at least partially aligned with the location of the thermochromic indicator. The color of the thermochromic indicator may be a first color (e.g., a dark color such as black or alternatively a light color such as red) if the temperature of the container 102 at the location of the thermochromic indicator is below a threshold temperature (e.g., ninety degrees Fahrenheit), and the color of the thermochromic indicator may be a second color (e.g., a light color such as red or alternatively a dark color such as black) that is different from the first color if the temperature of the container at the location of the thermochromic indicator is above the threshold temperature. The threshold temperature may be in the range of fifty to one hundred fifty degrees Fahrenheit. As another example, the threshold temperature may be in the range of eighty to one hundred twenty degrees Fahrenheit.

To illustrate, the temperature strip 122 may be attached to the container 102 on the outside of the container 102, thereby covering a portion of the container 102. For example, the temperature strip 122 may be attached to the container 102 magnetically or using an adhesive. The temperature strip 122 may be at least partially located elevation-wise below the location of the fire tube 106 that inside the cavity 104. For example, the temperature strip 122 may extend upwards toward the fire tube 106 from below the fire tube 106. The temperature of the container 102 at a particular location on the outside of the container 102 may depend on whether the container 102 contains the solid 120 at a corresponding inside location/area of the cavity 104 of the container 102 that is at least partially aligned with the particular location of the container 102 on the outside of the container 102. For example, the temperature of the container 102 at the location of the temperature strip 122 on the outside of the container 102 may depend on whether the container 102 contains the solid 120 at an inside location/area of the cavity 104 that is at least partially aligned with the location of the temperature strip 122 on the outside of the container 102. The colors of the temperature strip 122 may depend on the temperature of the container 102 at the location of the temperature strip 122 on the container 102.

Indeed, different portions of the temperature strip 122 that are in contact with different areas of the container 102 having different temperatures may have different colors. For example, the temperature strip 122 may include a thermochromic material, such as a liquid crystal material, which can be formulated to have different colors corresponding to different ranges of temperatures. The temperature strip 122, entirely or a portion thereof, may have a first color (e.g., black or alternatively red) when being exposed to a temperature below the threshold temperature or in a particular range below the threshold temperature. The temperature strip 122, entirely or a portion thereof, may have a second color (e.g., red or alternatively black) when being exposed to a temperature above the threshold temperature or in a particular range above the threshold temperature. For example, a portion 126 of the temperature strip 122 that is aligned with the location of the solid 120 inside the cavity 104 may have a first color (e.g., a dark color or alternatively a light color) and a portion 128 of the temperature strip 122 that is not aligned with the location of the solid 120 inside the cavity 104 may have a second color (e.g., a light color or alternatively a dark color). To be clear, a first color of the temperature strip 122 or a portion thereof that is relatively lighter or darker color may be used to indicate a temperature of the container 102 that is below the threshold temperature, and a second color that is different from the first color and that is a relatively lighter or darker color may be used to indicate a temperature of the container 102 that is above the threshold temperature.

To illustrate, because the solid 120 that includes sand, paraffins, iron sulfide, rock, wax, and/or other material(s), may result in a lower temperature of the container 102 at areas of the container 102 covered by the solid 120, the portion 126 of the temperature strip 122 that is aligned with the location of the solid 120 inside the cavity 104 may have a different color than the portion 128 of the temperature strip 122 that is not aligned with the location of the solid 120. For example, the temperature of the container 102 at the location of the portion 126 aligned with the solid 120 may be below a threshold temperature (e.g., a threshold temperature of ninety degrees Fahrenheit), and the temperature of the container 102 at the location of the portion 128 of the temperature strip 122 that is not aligned with the location of the solid 120 may be above the threshold temperature. As such, the color of the temperature strip 122 may indicate the level (vertically) of the solid 120 inside the cavity 104 of the container 102. For example, the level of the solid 120 in the cavity 104 may be at a boundary 130 between the portions 126, 128. The threshold temperature may be in a range of fifty to one hundred fifty degrees Fahrenheit, for example, depending on the operating environment. As another example, the threshold temperature may be in a range of eighty to one hundred twenty degrees Fahrenheit.

In some example embodiments, the temperature strip 122 may include solid level markers 124 corresponding to different vertical levels of the solid 120 inside the cavity 104. For example, the solid level markers 124 may include numbers, letters, and/or symbols corresponding to different levels of the solid 120 inside the cavity 104. To illustrate, a person may visually inspect the temperature strip 122 and record the location of the boundary 130 as indicated by a solid level marker of the solid level markers 124 that is, for example, the closest to the boundary 130 on the solid level markers 124. In general, the temperature strip 122 is attached to the container 102 at a location corresponding to an area of the cavity 104 and to the inside surface of the container 102 where the solid 120 is likely to accumulate.

By using the temperature strip 122, which is made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 100 may be avoided if the level of the solid 120 is estimated to be low.

Although FIG. 1A shows the temperature strip 122 on one side of the horizontal fluid separator 100, the temperature strip 122 may extend to the opposite side of the container 102 underneath the container 102. In some alternative embodiments, the horizontal fluid separator 100 may include one or more temperature strips than shown without departing from the scope of this disclosure. In some alternative embodiments, the horizontal fluid separator 100 may include one or more temperature strips on the longitudinal side of the container 102 that is opposite from the longitudinal side of the container 102 where the temperature strip 122 is located. In some alternative embodiments, the horizontal fluid separator 100 may include other components than shown without departing from the scope of this disclosure. In some alternative embodiments, the horizontal fluid separator 100 may have a different shape than shown without departing from the scope of this disclosure. In some alternative embodiments, the temperature strip 122 may be at a different location than shown without departing from the scope of this disclosure. In some alternative embodiments, the temperature strip 122 may extend, elevation-wise, above the location of the fire tube 106 without departing from the scope of this disclosure. In some alternative embodiments, one or more of the fluid inlet 110, the multiple outlets, and the solid drain 118 may be at a different location than shown without departing from the scope of this disclosure.

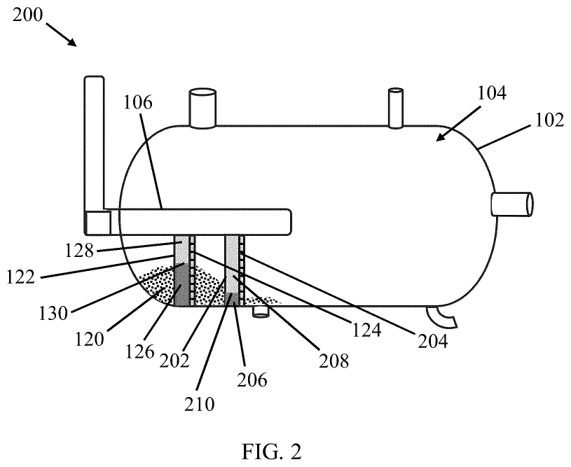

FIG. 2 illustrates a horizontal fluid separator 200 with temperature strips 122, 202 for estimating solid level in the horizontal fluid separator 200 according to another example embodiment. In general, the horizontal fluid separator 200 corresponds to the horizontal fluid separator 100 of FIG. 1A with the addition of the temperature strip 202 adjacent to the temperature strip 122. The temperature strips 122, 202 may include a thermochromic material, such as a liquid crystal material, which can be formulated to have different colors corresponding to different ranges of temperatures.

In some example embodiments, the horizontal fluid separator 200 includes the container 102 having the cavity 104. In FIG. 2, the container 102 is shown as transparent and some components of the horizontal fluid separator 200, such as a diverter plate, are omitted for clarity of illustration. The horizontal fluid separator 200 may include the fire tube 106 that extends into the cavity 104 of the container 102. To avoid damage to the fire tube 106, the solid 120 may be removed from the cavity 104 before the solid 120 accumulates and reaches the fire tube 106.

In some example embodiments, the horizontal fluid separator 200 includes the temperature strips 122, 202 that are thermochromic indicators. For example, the level of the solid 120 in the cavity 104 may be estimated based on the colors of the temperature strips 122, 202 that depend on the temperature of the container 102 at the locations of the temperature strips 122, 202. The temperature strips 122, 202 may be attached to the container 102 on the outside of the container 102, thereby covering portions of the container 102. For example, the temperature strips 122, 202 may be attached to the container 102 magnetically or using an adhesive. The temperature strips 122, 202 may be at least partially located elevation-wise below the location of the fire tube 106 that is inside the cavity 104. For example, the temperature strips 122, 202 may extend upwards toward the fire tube 106 from below the fire tube 106. As described above, the temperature of the container 102 at locations on the outside of the container 102 may depend on whether the solid 120 is on areas of the container 102 inside the cavity 104 that correspond to the locations on the outside of the container 102.

For example, the temperature of the container 102 at the location of the temperature strip 122 on the outside of the container 102 may depend on whether the container 102 contains the solid 120 at an inside location/area of the cavity 104 that is at least partially aligned with the location of the temperature strip 122 on the outside of the container 102. As another example, the temperature of the container 102 at the location of the temperature strip 202 on the outside of the container 102 may depend on whether the container 102 contains the solid 120 at an inside location/area that is at least partially aligned with the location of the temperature strip 202 on the outside of the container 102. The colors of the temperature strips 122, 202 may depend on the temperature of the container 102 at the locations of the temperature strips 122, 202, respectively, and thus may be indicative of the level of the solid 120 in the cavity 104 of the container 102.

As described above with respect to FIGS. 1A and 1B, different portions of the temperature strip 122 that are in contact with different areas of the container 102 having different temperatures may have different colors. In general, the temperature strip 202 may operate in the manner described with respect to the temperature strip 122. To illustrate, different portions of the temperature strip 202 that are in contact with different areas of the container 102 having different temperatures may have different colors.

In some example embodiments, each one of the temperature strips 122, 202, entirely or a portion thereof, may have a first color (e.g., black or alternatively red) when being exposed to a temperature below the threshold temperature or in a particular range below the threshold temperature (e.g., a threshold temperature of ninety degrees Fahrenheit). The threshold temperature may be in a range of fifty to one hundred fifty degrees Fahrenheit, for example, depending on the operating environment. As another example, the threshold temperature may be in a range of eighty to one hundred twenty degrees Fahrenheit. Each one of the temperature strips 122, 202, entirely or a portion thereof, may have a second color (e.g., red or alternatively black) when being exposed to a temperature above the threshold temperature or in a particular range above the threshold temperature. For example, the portion 126 of the temperature strip 122 that is aligned with the solid 120 and thus exposed to a temperature of the container 102 that is below the threshold temperature may have a first color (e.g., a dark color), and the portion 128 of the temperature strip 122 that is not aligned with the solid 120 inside the cavity 104 and thus exposed to a temperature of the container 102 that is above the threshold temperature may have a second color (e.g., a light color). A portion 204 of the temperature strip 202 that is aligned with the solid 120 may have a first color (e.g., a dark color), and a portion 208 of the temperature strip 202 that is not aligned with the location of the solid 120 may have a second color (e.g., a light color). To be clear, the colors of the temperature strips 122, 202 and/or portions thereof described or suggested herein are example colors, and the temperature strips 122, 202 and portions thereof may have other colors without departing from the scope of this disclosure.

As such, the colors of the temperature strips 122, 202 may indicate levels (vertically) of the solid 120 inside the cavity 104 of the container 102. For example, the level of the solid 120 in an area of the cavity 104 may be at the boundary 130 between the portions 126, 128 of the temperature strip 122, and the level of the solid 120 in another area of the cavity 104 may be at a boundary 210 between the portions 206, 208 of the temperature strip 202. To be clear, because the accumulation of the solid 120 can be different in different areas of the cavity 104, the level of the solid 120 indicated by the colors of temperature strips 122, 202 may be different depending on the locations of the temperature strips 122, 202 on the outside of the container 102. In general, the temperature strips 122, 202 are attached to the container 102 at locations corresponding to areas of the cavity 104 and inside surface of the container 102 that are likely to have accumulation of the solid 120.

In some example embodiments, the temperature strip 202 may include solid level markers 204 corresponding to different vertical levels of the solid 120 inside the cavity 104 as described with respect to the solid level markers 124 of the temperature strip 122 and FIGS. 1A and 1B. To illustrate, a person may visually inspect the temperature strips 122 and record the location of the boundary 130 as indicated by a solid level marker of the solid level markers 124 that is, for example, the closest level marker of the solid level markers 124 to the boundary 130. The person may also visually inspect the temperature strips 202 and record the location of the boundary 210 as indicated by a solid level marker of the solid level markers 204 that is, for example, the closest level marker of the solid level markers 204 to the boundary 210.

By using the temperature strips 122, 202, the level of the solid 120 in the cavity 104 of the container 102 can be visually and non-invasively estimated at different areas of the cavity 104 of the container 102. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 200 may be avoided if the level of the solid 120 is estimated to be low.

Although FIG. 2 shows the temperature strips 122, 202 on one side of the horizontal fluid separator 200, the temperature strips 122, 202 may extend to the opposite side of the container 102 underneath the container 102. In some alternative embodiments, the horizontal fluid separator 200 may include one or more temperature strips than shown without departing from the scope of this disclosure. In some alternative embodiments, the horizontal fluid separator 200 may include one or more temperature strips on the longitudinal side of the container 102 that is opposite from the longitudinal side of the container 102 where the temperature strips 122. 202 are located. In some alternative embodiments, the horizontal fluid separator 200 may include other components than shown without departing from the scope of this disclosure. In some alternative embodiments, the horizontal fluid separator 200 may have a different shape than shown without departing from the scope of this disclosure. In some alternative embodiments, the temperature strips 122, 202 may be at a different location than shown without departing from the scope of this disclosure. In some alternative embodiments, the temperature strips 122, 202 may extend, elevation-wise, above the location of the fire tube 106 without departing from the scope of this disclosure.

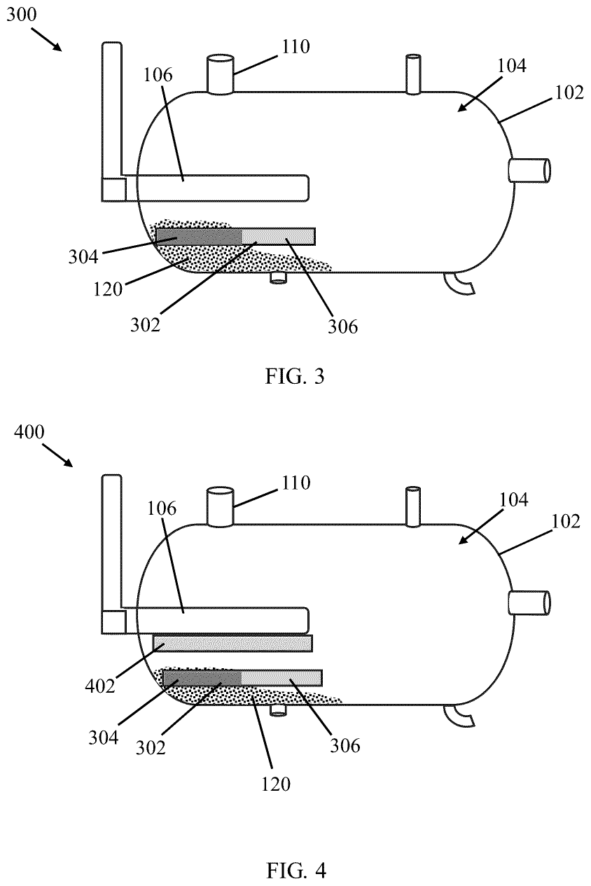

FIG. 3 illustrates a horizontal fluid separator 300 of FIG. 1 with a temperature strip 302 for estimating solid level in the horizontal fluid separator 300 according to another example embodiment. In some example embodiments, the horizontal fluid separator 300 includes the container 102 described above with respect to FIGS. 1A and 1B. The horizontal fluid separator 300 may include the fire tube 106 that extends into the cavity 104 of the container 102. In FIG. 3, the container 102 is shown as transparent and some components of the separator 300, such as a diverter plate, are omitted for clarity of illustration.

In some example embodiments, the temperature strip 302 may be attached to the container 102 on the outside of the container 102, thereby covering a portion of the container 102. For example, the temperature strip 302 may be attached to the container 102 magnetically or using an adhesive. The temperature strip 302 may be located elevation-wise below the location of the fire tube 106 that is inside the cavity 104. For example, the temperature strip 302 may extend horizontally along a longitudinal side of the container 102, where the temperature strip 302 extends horizontally for at least a portion of a horizontal length of the container 102. In general, the temperature strip 302 is attached to the container 102 at a location corresponding to areas of the cavity 104 and inside surface of the container 102 that are likely to have accumulation of the solid 120.

As described above, the temperature of the container 102 at a particular location on the outside of the container 102 may depend on whether the cavity 104 of the container 102 contains the solid 120 at a corresponding inside location/area of the cavity 104. For example, the temperature of the container 102 at the location of the temperature strip 302 on the outside of the container 102 may depend on whether the container 102 contains the solid 120 at an inside location/area of the cavity 104 that is at least partially aligned with the location of the temperature strip 302 on the outside of the container 102. Because the temperature strip 302 is a thermochromic indicator, the colors of the temperature strip 302 may depend on the temperature of the container 102 at the location of the temperature strip 302 on the container 102.

Indeed, different portions of the temperature strip 302 that are in contact with different areas of the container 102 having respective different temperatures may have different colors. For example, the temperature strip 302 may include a thermochromic material, such as a liquid crystal material, which can be formulated to have different colors corresponding to different ranges of temperatures. The temperature strip 302, entirely or a portion thereof, may have a first color (e.g., black) when being exposed to a temperature below a threshold temperature (e.g., a threshold temperature of ninety degrees Fahrenheit) or in a particular range below the threshold temperature. The temperature strip 302, entirely or a portion thereof, may have a second color (e.g., red) when being exposed to a temperature above the threshold temperature or in a particular range above the threshold temperature. The threshold temperature may be in a range of fifty to one hundred fifty degrees Fahrenheit, for example, depending on the operating environment. As another example, the threshold temperature may be in the range of eighty to one hundred twenty degrees Fahrenheit.

For example, a portion 304 of the temperature strip 302 that is aligned with the location of the solid 120 inside the cavity 104 may have a first color, and a portion 306 of the temperature strip 302 that is not aligned with the location of the solid 120 inside the cavity 104 may have a second color. As such, the portion 304 of the temperature strip 302 may indicate that the level of the solid 120 in the cavity 104 of the container 102 is at least at the location, elevation-wise, of the temperature strip 302. In general, the temperature strip 302 is attached to the container 102 at a location corresponding to areas of the cavity 104 and inside surface of the container 102 that are likely to have accumulation of the solid 120. To be clear, the colors of the temperature strip 304 and/or portions thereof described or suggested herein are example colors, and the temperature strip 304 and portions thereof may have other colors without departing from the scope of this disclosure.

By using the temperature strip 302, which is made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 100 may be avoided if the level of the solid 120 is estimated to be low.

Although FIG. 3 shows the temperature strip 302 on one longitudinal side of the horizontal fluid separator 300, the temperature strip 302 may extend to the opposite longitudinal side of the container 102. In some alternative embodiments, the horizontal fluid separator 300 may include one or more temperature strips than shown without departing from the scope of this disclosure. In some alternative embodiments, the horizontal fluid separator 300 may include one or more temperature strips on the longitudinal side of the container 102 that is opposite from the longitudinal side of the container 102 where the temperature strip 302 is located. In some alternative embodiments, the horizontal fluid separator 300 may include other components than shown without departing from the scope of this disclosure. In some alternative embodiments, the horizontal fluid separator 300 may have a different shape than shown without departing from the scope of this disclosure. In some alternative embodiments, the temperature strip 302 may be at a different location than shown without departing from the scope of this disclosure. In some alternative embodiments, the temperature strip 302 may extend, elevation-wise, above the location of the fire tube 106 without departing from the scope of this disclosure.

FIG. 4 illustrates a horizontal fluid separator 400 with temperature strips 302, 402 for estimating solid level in the horizontal fluid separator 400 according to another example embodiment. In general, the horizontal fluid separator 400 corresponds to the horizontal fluid separator 300 of FIG. 3 with the addition of the temperature strip 402. The temperature strip 402 may include a thermochromic material, such as a liquid crystal material, which can be formulated to have different colors corresponding to different ranges of temperatures in the manner described above with respect to the temperature strip 302. In general, the temperature strips 302, 402 are attached to the container 102 at locations corresponding to areas of the cavity 104 and inside surface of the container 102 that are likely to have accumulation of the solid 120.

In some example embodiments, the horizontal fluid separator 400 includes the container 102 having the cavity 104. In FIG. 4, the container 102 is shown as transparent and some components of the horizontal fluid separator 400, such as a diverter plate, are omitted for clarity of illustration. The horizontal fluid separator 400 may include the fire tube 106 that extends into the cavity 104 of the container 102. To avoid damage to the fire tube 106, the solid 120 may be removed from the cavity 104 before the solid 120 accumulates and reaches the fire tube 106.

In some example embodiments, the temperature strip 402 may be located, elevation-wise, above the temperature strip 302 and closer to the fire tube 106. As the solid 120 accumulates in the container 102, the level of the solid 120 may reach, elevation-wise, the location/height of the temperature strip 302 as shown by the color (e.g., a relatively darker color) of the portion 304 of the temperature strip 302 corresponding to a temperature of the container that is below the threshold temperature. Because the solid 120 has not reached the location/height of the temperature strip 302 along the portion 306 of the temperature strip 302, the color of the portion 306 may be another color (e.g., a relatively lighter color). Because the solid 120 has not accumulated above the temperature strip 302 to reach, elevation-wise, the location of the temperature strip 402, the temperature strip 402 may be exposed to a temperature of the container 102 that is above the threshold temperature and thus may have a corresponding color (e.g., a relatively lighter color). For example, the color of the temperature strip 402 may be substantially the same color as the portion 306 of the temperature strip 302. If the solid 120 accumulates and reaches, elevation-wise, the location of the temperature strip 402, the color of at least a portion of the temperature strip 402 may change, for example, to another color corresponding to a temperature of the container 102 at the location of the temperature strip 402 that is lower than the threshold temperature. To be clear, the colors of the temperature strips 302, 402 and/or portions thereof described or suggested herein are example colors, and the temperature strips 302, 402 and portions thereof may have other colors without departing from the scope of this disclosure.

In some example embodiments, a person may visually inspect the temperature strips 302, 402 and record the colors of the temperature strips 302, 402 and the level of the solid 120 that may be indicated by the colors of the temperature strips 302, 402. For example, the person may record that the level of the solid 120 is at least the height of the temperature strip 302 relative to the bottom of the container 102 and that the level of the solid 120 has not reached the height of the temperature strip 402.

By using the temperature strip 302, 402, which are made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 400 may be avoided if the level of the solid 120 is estimated to be low.

Although FIG. 4 shows the temperature strips 302, 304 on one longitudinal side of the horizontal fluid separator 400, the temperature strips 302, 304 may extend to the opposite longitudinal side of the container 102. In some alternative embodiments, the horizontal fluid separator 400 may include one or more temperature strips than shown without departing from the scope of this disclosure. In some alternative embodiments, the horizontal fluid separator 400 may include one or more temperature strips on the longitudinal side of the container 102 that is opposite from the longitudinal side of the container 102 where the temperature strips 302, 304 are located. In some alternative embodiments, the horizontal fluid separator 400 may include other components than shown without departing from the scope of this disclosure. In some alternative embodiments, the horizontal fluid separator 400 may have a different shape than shown without departing from the scope of this disclosure. In some alternative embodiments, the temperature strips 302, 304 may be at different locations than shown without departing from the scope of this disclosure. In some alternative embodiments, the temperature strip 402 may partially overlap or extend, elevation-wise, above the location of the fire tube 106 without departing from the scope of this disclosure.

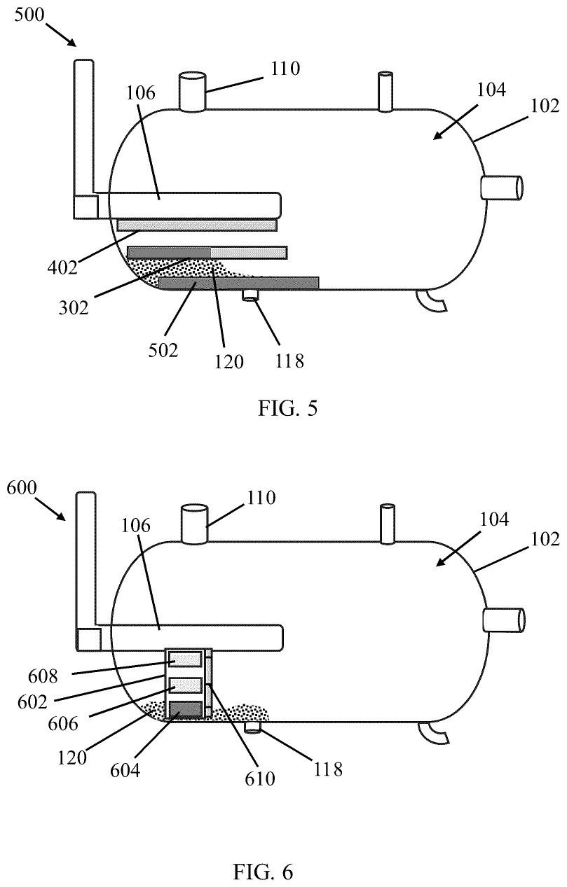

FIG. 5 illustrates a horizontal fluid separator 500 with temperature strips 302, 402, 502 for estimating solid level in the horizontal fluid separator 500 according to another example embodiment. In general, the horizontal fluid separator 500 corresponds to the horizontal fluid separator 400 of FIG. 4 with the addition of the temperature strip 502. The temperature strip 502 may include a thermochromic material, such as a liquid crystal material, which can be formulated to have different colors corresponding to different ranges of temperatures in the manner described above with respect to the temperature strip 302. In general, the temperature strips 302, 402, 502 are attached to the container 102 at locations corresponding to areas of the cavity 104 and inside surface of the container 102 that are likely to have accumulation of the solid 120.

In some example embodiments, the horizontal fluid separator 500 includes the temperature strip 502 that is located below the temperature strip 302. In contrast to the temperature strips 302, 402, the temperature strip 502 may indicate a smaller accumulation of the solid 120 in the cavity 104 of the container 102. For example, in FIG. 5, the color of the temperature strip 502 may indicate the accumulation of the solid 120 that is at least the height of the temperature strip 502 from the bottom of the container 102. As the accumulation of the solid 120 increases and reaches, elevation-wise, the level of the temperature strip 302, the portion 304 of the temperature strip 302 may have a color indicative of the level of the solid 120 that has at least reached, elevation-wise, the location of the temperature strip 302. The color of the temperature strip 402 may indicate that the level of the solid 120 is elevation-wise below the location of the temperature strip 402. To be clear, the colors of the temperature strips 302, 402, 502 and/or portions thereof described or suggested herein are example colors, and the temperature strips 302, 402, 502 and portions thereof may have other colors without departing from the scope of this disclosure.

By using the temperature strip 302, 402, 502, which are made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 500 may be avoided if the level of the solid 120 is estimated to be low.

Although FIG. 5 shows the temperature strips 302, 402, 502 on one longitudinal side of the horizontal fluid separator 400, the temperature strips 302, 402, 502 may extend to the opposite longitudinal side of the container 102. In some alternative embodiments, the horizontal fluid separator 500 may include one or more temperature strips than shown without departing from the scope of this disclosure. In some alternative embodiments, the horizontal fluid separator 500 may include one or more temperature strips on the longitudinal side of the container 102 that is opposite from the longitudinal side of the container 102 where the temperature strips 302, 402, 502 are located. In some alternative embodiments, the horizontal fluid separator 500 may include other components than shown without departing from the scope of this disclosure. In some alternative embodiments, the horizontal fluid separator 500 may have a different shape than shown without departing from the scope of this disclosure. In some alternative embodiments, the temperature strips 302, 402, 502 may be at different locations than shown without departing from the scope of this disclosure. In some alternative embodiments, the temperature strip 402 may partially overlap or extend, elevation-wise, above the location of the fire tube 106 without departing from the scope of this disclosure. In some alternative embodiments, the temperature strips 302, 402, 502 may be closer together than shown without departing from the scope of this disclosure.

FIG. 6 illustrates a horizontal fluid separator 600 with a temperature strip 602 for estimating solid level in the horizontal fluid separator 600 according to another example embodiment. In some example embodiments, the horizontal fluid separator 600 includes the container 102 described above with respect to FIGS. 1A and 1B. The horizontal fluid separator 600 may include the fire tube 106 that extends into the cavity 104 of the container 102. In FIG. 6, the container 102 is shown as transparent and some components of the horizontal fluid separator 600, such as a diverter plate, are omitted for clarity of temperature strip illustration.

In some example embodiments, the temperature strip 602 may be attached to the container 102 on the outside of the container 102, thereby covering a portion of the container 102. The temperature strip 602 may be attached to the container 102 at a location corresponding to areas of the cavity 104 and inside surface of the container 102 that are likely to have accumulation of the solid 120. The temperature strip 602 may be attached to the container 102 magnetically or using an adhesive. The temperature strip 602 may be at least partially located elevation-wise below the location of the fire tube 106 that is inside the cavity 104. For example, the temperature strip 602 may extend upwards toward the fire tube 106 from below the fire tube 106.

In some example embodiments, in contrast to the temperature strip 122 of the horizontal fluid separator 100 of FIGS. 1A-2, the temperature strip 602 may include thermochromic indicator elements 604, 606, 608. For example, each thermochromic indicator element of the thermochromic indicator elements 604, 606, 608 may include a thermochromic material, such as a liquid crystal material, which can be formulated to have different colors corresponding to different ranges of temperatures in the manner described above with respect to the temperature strip 302. For example, the thermochromic indicator elements 604, 606, 608 may each have a first color when exposed to a temperature or a range of temperatures below a threshold temperature (e.g., a threshold temperature of ninety degrees Fahrenheit) and a second color when exposed to a temperature or a range of temperatures above the threshold temperature. For example, the thermochromic indicator elements 604, 606, 608 may be responsive to different temperature ranges in the same manner or differently with respect to each other. The threshold temperature may be in a range of fifty to one hundred fifty degrees Fahrenheit, for example, depending on the operating environment. As another example, the threshold temperature may be in the range of eighty to one hundred twenty degrees Fahrenheit.

In some example embodiments, the level of the solid 120 in the cavity 104 may be such that the temperature of the container 102 at the location of the thermochromic indicator element 604 is below the threshold temperature and such that the temperature of the container 102 at the locations of the thermochromic indicator elements 606, 608 is above the threshold temperature. As such, the thermochromic indicator element 604 may have a color (e.g., a dark color) indicative of the temperature of the container 102 at the thermochromic indicator element 604. Thus, the color of the thermochromic indicator element 604 may indicate that the level of the solid 120 in the cavity 104 is at least aligned with the location of the thermochromic indicator element 604. The thermochromic indicator elements 606, 608 may have the same or similar color (e.g., a light color) indicative of the temperature of the container 102 at the locations of the thermochromic indicator elements 606, 608. Thus, the color of the thermochromic indicator elements 606, 608 may indicate that the level of the solid 120 in the cavity 104 is elevation-wise below the location of the thermochromic indicator elements 606, 608. If the level of the solid 120 increases, the color of one or both of the thermochromic indicator elements 606, 608 may change to indicate the level of the solid 120 based on the temperature of the container 102.

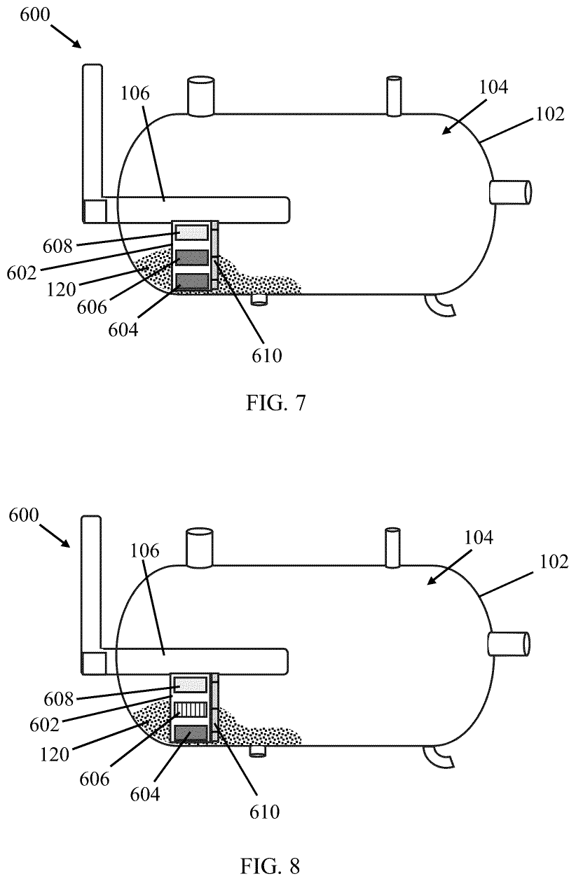

For example, FIG. 7 illustrates the horizontal fluid separator 600 with the temperature strip 602 of FIG. 6 and a different solid level in the horizontal fluid separator 600 according to an example embodiment. To illustrate, in FIG. 7, the thermochromic indicator element 606, which is above the thermochromic indicator element 604, has a color indicating that the level of the solid 120 is elevation-wise at the location of the thermochromic indicator element 606, which is higher than the level of the solid 120 in the cavity 104 indicated in FIG. 6 by the thermochromic indicator element 604. In some alternative embodiments, the color of the thermochromic indicator element 606 may be different from the color of the thermochromic indicator element 604. For example, the thermochromic indicator element 606 may be designed to have a different color from the color of the thermochromic indicator element 604 when both are exposed to the same temperature or temperature range below a threshold temperature. Alternatively, the thermochromic indicator elements 604, 606 may be designed to be responsive to different temperature ranges below the threshold temperature, where the thermochromic indicator elements 604, 606 respond with different colors from each other.

For example, FIG. 8 illustrates the horizontal fluid separator 600 with the temperature strip 602 of FIG. 6 for estimating solid level in the horizontal fluid separator according to another example embodiment. FIG. 8 illustrates the thermochromic indicator elements 604, 606 having different colors from each other in response to being exposed to different temperatures of the container 102 below the threshold temperature at the respective locations of the thermochromic indicator elements 604, 606 on the outside of the container 102. For example, in contrast to the color of the thermochromic indicator element 606 in FIG. 7, in FIG. 8, the thermochromic indicator element 606 may have a different color (illustratively represented by a different pattern), in response to being exposed to a temperature that is below the threshold temperature.

Referring to FIGS. 6-8, in some example embodiments, the temperature strip 602 includes solid level markers 610 corresponding to different vertical levels of the solid 120 inside the cavity 104. For example, the solid level markers 610 may include numbers, letters, and/or symbols corresponding to different levels of the solid 120 inside the cavity 104. To illustrate, a person may visually inspect the temperature strip 602 and record the solid level marker of the solid level markers 610 that is, for example, associated with the highest one of the thermochromic indicator elements 604, 606, 608 that has a color indicative of the level of the solid 120 in the cavity 104. In general, the temperature strip 602 is attached to the container 102 at a location corresponding to an area of the cavity 104 and to the inside surface of the container 102 where the solid 120 is likely to accumulate. To be clear, the colors of the thermochromic indicator elements 604, 606, 608 described or suggested herein are example colors, and the thermochromic indicator elements 604, 606, 608 may have other colors without departing from the scope of this disclosure.

By using the temperature strip 602, which is made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 600 may be avoided if the level of the solid 120 is estimated to be low.

Although FIGS. 6-8 show the temperature strip 602 on one side of the horizontal fluid separator 600, the temperature strip 602 may extend to the opposite side of the container 102 underneath the container 102. In some alternative embodiments, the horizontal fluid separator 600 may include one or more temperature strips than shown without departing from the scope of this disclosure. In some alternative embodiments, the horizontal fluid separator 600 may include one or more temperature strips on the longitudinal side of the container 102 that is opposite from the longitudinal side of the container 102 where the temperature strip 602 is located. In some alternative embodiments, the horizontal fluid separator 600 may include other components than shown without departing from the scope of this disclosure. In some alternative embodiments, the horizontal fluid separator 600 may have a different shape than shown without departing from the scope of this disclosure. In some alternative embodiments, the temperature strip 602 may be at a different location than shown without departing from the scope of this disclosure. In some alternative embodiments, the temperature strip 602 may extend, elevation-wise, above the location of the fire tube 106 without departing from the scope of this disclosure. In some alternative embodiments, the solid level markers 610 may be omitted without departing from the scope of this disclosure.

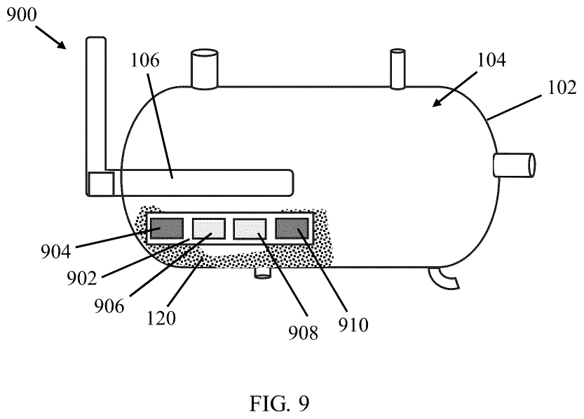

FIG. 9 illustrates a horizontal fluid separator 900 with a temperature strip 902 for estimating solid level in the horizontal fluid separator 900 according to another example embodiment. In some example embodiments, the horizontal fluid separator 900 includes the container 102 described above with respect to FIGS. 1A and 1B. The horizontal fluid separator 900 may include the fire tube 106 that extends into the cavity 104 of the container 102. In FIG. 9, the container 102 is shown as transparent and some components of the horizontal fluid separator 600, such as a diverter plate, are omitted for clarity of temperature strip illustration.

In some example embodiments, the temperature strip 902 may be attached to the container 102 on the outside of the container 102, thereby covering a portion of the container 102. The temperature strip 902 may be attached to the container 102 magnetically or using an adhesive. The temperature strip 902 may be located elevation-wise below the location of the fire tube 106 that is inside the cavity 104. For example, the temperature strip 902 may extend horizontally along a longitudinal side of the container 102, where the temperature strip 902 extends horizontally for at least a portion of a horizontal length of the container 102. In general, the temperature strip 902 is attached to the container 102 at a location corresponding to areas of the cavity 104 and inside surface of the container 102 that are likely to have accumulation of the solid 120.

In some example embodiments, in contrast to the temperature strip 302 of the horizontal fluid separator 300 of FIG. 3, the temperature strip 902 may include thermochromic indicator elements 904, 906, 908, 910. For example, each thermochromic indicator element of the thermochromic indicator elements 904, 906, 908, 910 may include a thermochromic material, such as a liquid crystal material, which can be formulated to have different colors corresponding to different ranges of temperatures in the manner described above with respect to the temperature strip 302 of FIG. 3. For example, the thermochromic indicator elements 904, 906, 908, 910 may each have a first color when exposed to a temperature or a range of temperatures below a threshold temperature (e.g., a threshold temperature of ninety degrees Fahrenheit) and a second color when exposed to a temperature or a range of temperatures above the threshold temperature. The threshold temperature may be in the range of fifty to one hundred fifty degrees Fahrenheit, for example, depending on the operating environment. As another example, the threshold temperature may be in the range of eighty to one hundred twenty degrees Fahrenheit.

In some example embodiments, the level of the solid 120 in the cavity 104 may be such that the temperature of the container 102 at the location of the thermochromic indicator elements 904, 910 is below the threshold temperature and such that the temperature of the container 102 at the locations of the thermochromic indicator elements 906, 908 is above the threshold temperature. As such, the thermochromic indicator elements 904, 910 may each have a color (e.g., a dark color) indicative of the temperature of the container 102 at the location of the thermochromic indicator elements 904, 910 being below the threshold temperature. Thus, the color of the thermochromic indicator elements 904, 910 may indicate that the level of the solid 120 in the cavity 104 is elevation-wise at least as high as the location of the temperature strip 902 relative to the bottom of the container 102, particularly at areas of the cavity 104 aligned with the location of the thermochromic indicator elements 904, 910.

In some example embodiments, the thermochromic indicator elements 906, 908 may have the same or similar color (e.g., a light color) indicative of the temperature of the container 102 at the locations of the thermochromic indicator elements 906, 908 being above the threshold temperature. Thus, the color of the thermochromic indicator elements 906, 908 may indicate that the level of the solid 120 in the cavity 104 is elevation-wise below the location of the thermochromic indicator elements 906, 908, particularly at areas of the cavity 104 aligned with the location of the thermochromic indicator elements 906, 908. To be clear, in general, the temperature of the container 102 at a particular location on the outside of the container 102 is reduced as a result of the accumulation of the solid 120 in the cavity 104 primarily if the solid 120 covers the corresponding interior surface of the container 102. To be clear, the colors of the thermochromic indicator elements 904, 906, 908, 910 described or suggested herein are example colors, and the thermochromic indicator elements 904, 906, 908, 910 may have other colors without departing from the scope of this disclosure.

In some example embodiments, a person may visually inspect the temperature strip 602 and record the color of each thermochromic indicator element of the thermochromic indicator elements 904, 906, 908, 910 to estimate the level of the solid 120 in the cavity 104. By using the temperature strip 902, which is made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 600 may be avoided if the level of the solid 120 is estimated to be low.

Although FIG. 9 shows the temperature strip 902 on one side of the horizontal fluid separator 900, the temperature strip 902 may extend to the opposite side of the container 102. In some alternative embodiments, the horizontal fluid separator 900 may include one or more temperature strips than shown without departing from the scope of this disclosure. In some alternative embodiments, the horizontal fluid separator 900 may include one or more temperature strips on the longitudinal side of the container 102 that is opposite from the longitudinal side of the container 102 where the temperature strip 902 is located. In some alternative embodiments, the horizontal fluid separator 900 may include other components than shown without departing from the scope of this disclosure. In some alternative embodiments, the horizontal fluid separator 900 may have a different shape than shown without departing from the scope of this disclosure. In some alternative embodiments, the temperature strip 902 may be at a different location than shown without departing from the scope of this disclosure.

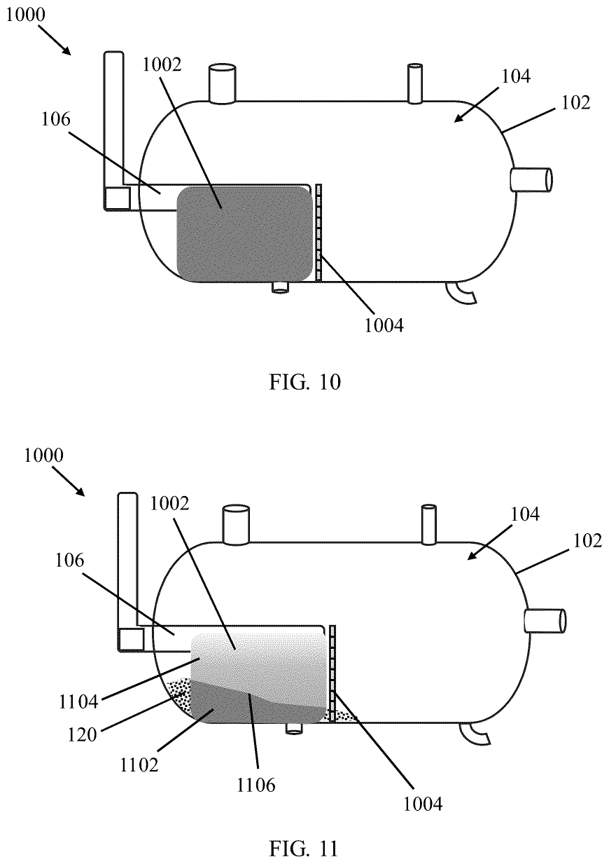

FIG. 10 illustrates a horizontal fluid separator 1000 with thermochromic paint 1002 for estimating solid level in the horizontal fluid separator 1000 according to an example embodiment, and FIG. 11 illustrates the horizontal fluid separator 1000 with the thermochromic paint 1002 of FIG. 10 indicating solid level in the horizontal fluid separator 1000 according to an example embodiment. In some example embodiments, the horizontal fluid separator 1000 includes the container 102 described above with respect to FIGS. 1A and 1B. The horizontal fluid separator 1000 may include the fire tube 106 that extends into the cavity 104 of the container 102. In FIG. 1000, the container 102 is shown as transparent and some components of the horizontal fluid separator 600, such as a diverter plate, are omitted for clarity of temperature strip illustration.

In some example embodiments, a portion of the container 102 on the outside of the container 102 may be painted or otherwise covered with the thermochromic paint 1002. In general, a portion of the outside of the container 102 that is painted with the thermochromic paint 1002 corresponds to areas of the cavity 104 and inside surface of the container 102 that are likely to have accumulation of the solid 120. As the solid 120 accumulates in the cavity 104 resulting in lowered temperature of the container 102 at locations of the solid 120, the color of portions of the thermochromic paint 1002 that are exposed to the lowered temperature of the container 102 may change, for example, to a darker color or a lighter. For example, the thermochromic paint 1002 may be formulated to have a first color (e.g., a dark color or a light color) when exposed to a temperature below a threshold temperature (e.g., a threshold temperature of ninety degrees Fahrenheit) and to have a second color or a gradient of one or more other colors when exposed to a temperature above the threshold temperature. The threshold temperature may be in the range of fifty to one hundred fifty degrees Fahrenheit, for example, depending on the operating environment. As another example, the threshold temperature may be in the range of eighty to one hundred twenty degrees Fahrenheit.

To illustrate, as shown in FIG. 11, a portion 1104 of the thermochromic paint 1002 may be exposed to a temperature or a range of temperatures below the threshold temperature, and a portion 1104 of the thermochromic paint 1002 may be exposed to a temperature or a range of temperatures above the threshold temperature. As such, the portions 1102, 1106 of the thermochromic paint 1002 may have different temperatures from each other. A boundary 1106 between the portions 1102, 1104 may be indicative of the level of the solid 120 in the cavity 104 of the container 102 along the corresponding inside surface of the container 102. To be clear, the color of the thermochromic paint 1002 in FIG. 10 may be before heat is dissipated into the cavity 104 of the container 102 by the fire tube 106.

In some example embodiments, the horizontal fluid separator 1000 may include solid level markers 1004 corresponding to different vertical levels of the solid 120 inside the cavity 104 as indicated by the boundary 1106 between the portions 1102, 1104 of the thermochromic paint 1002. To illustrate, a person may visually inspect the thermochromic paint 1002 and record the location of the boundary 1106 as indicated by the solid level markers 1004. In general, the thermochromic paint 1002 is painted on the container 102 at a location corresponding to an area of the cavity 104 and to the inside surface of the container 102 where the solid 120 is likely to accumulate.

By using the thermochromic paint 1002, which is made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 1000 may be avoided if the level of the solid 120 is estimated to be low.

Although FIG. 1000 shows the thermochromic paint 1002 on one side of the horizontal fluid separator 1000, the thermochromic paint 1002 may extend to the opposite side of the container 102 underneath the container 102. In some alternative embodiments, the horizontal fluid separator 1000 may include one or more temperature strips than shown without departing from the scope of this disclosure. In some alternative embodiments, the horizontal fluid separator 1000 may include thermochromic paint on the longitudinal side of the container 102 that is opposite from the longitudinal side of the container 102 where the thermochromic paint 1002 is located. In some alternative embodiments, the horizontal fluid separator 1000 may include other components than shown without departing from the scope of this disclosure. In some alternative embodiments, the horizontal fluid separator 1000 may have a different shape than shown without departing from the scope of this disclosure. In some alternative embodiments, the thermochromic paint 1002 may be at a different location than shown without departing from the scope of this disclosure. In some alternative embodiments, the thermochromic paint 1002 may extend, elevation-wise, above or below the location of the fire tube 106 without departing from the scope of this disclosure. In some alternative embodiments, the thermochromic paint 1002 may cover a smaller or larger area of the container 102 without departing from the scope of this disclosure.

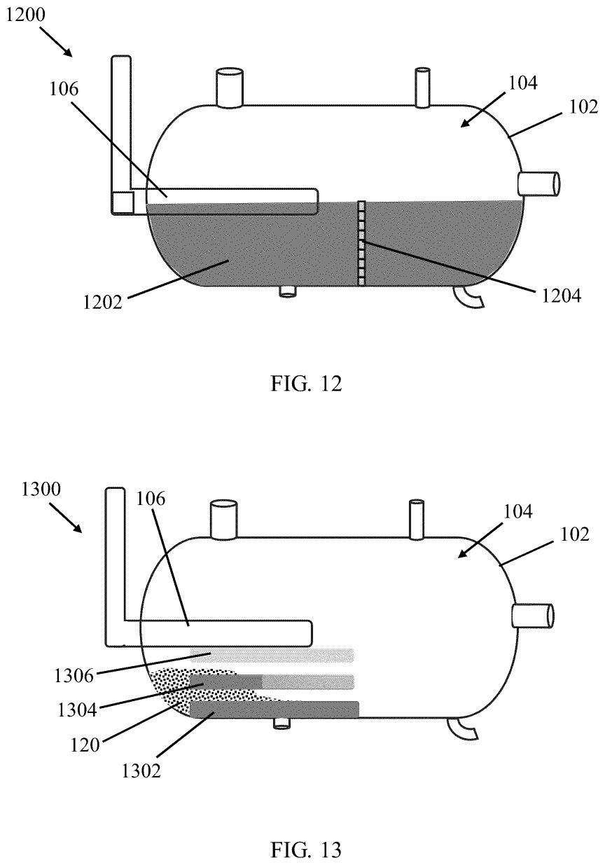

For example, FIG. 12 illustrates a horizontal fluid separator 1200 with a thermochromic paint 1202 for estimating solid level in the horizontal fluid separator 1200 according to another example embodiment. To illustrate, the thermochromic paint 1202 may be painted on or otherwise cover the bottom half of the container 102 on the outside of the container 102. One or more portions of the thermochromic paint 1202 may change color responsive to the corresponding temperature of the container 102 and thereby indicating the level of the solid 120 in the cavity 104 in the manner described above with respect to FIG. 11. A person may visually inspect the thermochromic paint 1202 and record the location of a boundary, if any, that separates different colors of the thermochromic paint 1202 as indicated by solid level markers 12-4. In general, the thermochromic paint 1202 is painted on the outside surface of the container 102 at a location corresponding to an area of the cavity 104 and to the inside surface of the container 102 where the solid 120 is likely to accumulate. A temperature of the container 102 that is above the threshold temperature may be indicated by a first color of the thermochromic paint 1202 or a portion thereof, where the first color may be a relatively lighter color (e.g., red or yellow) or a relatively darker color (e.g., black). A temperature of the container 102 that is below the threshold temperature may be indicated by a second color of the thermochromic paint 1202 or a portion thereof, where the second color is different from the first color and can be visually distinguishable from the first color.

In some alternative embodiments, stripes of thermochromic paint may be painted on the outside of the container 102 covering portions of the container 102. For example, FIG. 13 illustrates a horizontal fluid separator 1300 with thermochromic paint stripes 1302, 1304, 1306 for estimating solid level in the horizontal fluid separator according to another example embodiment. The thermochromic paint stripes 1302, 1304, 1306 may be painted on the outside surface of the container 102 and may be responsive to the temperature of the container 102 at the respective locations of the thermochromic paint stripes 1302, 1304, 1306. In general, portions of the outside of the container 102 that are painted with the thermochromic paint stripes 1302, 1304, 1306 correspond to areas of the cavity 104 and inside surface of the container 102 that are likely to have accumulation of the solid 120.

In some example embodiments, as the solid 120 accumulates in the cavity 104 resulting in lowered temperature of the container 102 at locations of the solid 120, the colors of at least portions of the thermochromic paint stripes 1302, 1304, 1306 that are exposed to the lowered temperature of the container 102 may change, for example, to a darker color or a lighter color. For example, the thermochromic paint stripes 1302, 1304, 1306 may be formulated to have a first color (e.g., a darker color or a lighter color) when exposed to a temperature below a threshold temperature (e.g., a threshold temperature of ninety degrees Fahrenheit) and to have a second color or a gradient of one or more other colors when exposed to a temperature above the threshold temperature. The threshold temperature may be in the range of fifty to one hundred fifty degrees Fahrenheit, for example, depending on the operating environment. As another example, the threshold temperature may be in the range of eighty to one hundred twenty degrees Fahrenheit.

For example, the thermochromic paint stripe 1302 may have a darker color in response to the temperature of the container 102 at the location of the thermochromic paint stripe 1302 being below the threshold temperature as a result of the solid 120 covering the corresponding inside surface of the container 102. A portion of the thermochromic paint stripe 1304 may have a darker color in response to the temperature of the container 102 at the location of the portion of thermochromic paint stripe 1304 being below the threshold temperature as a result of the solid 120 covering the corresponding inside surface of the container 102. The remaining portion of the thermochromic paint stripe 1304 may have a lighter color indicative of the temperature of the container 102 at the location of the particular portion of the thermochromic paint stripe 1304 being above the threshold temperature. The thermochromic paint stripe 1306 may have a lighter color indicative of the temperature of the container 102 at the location of the thermochromic paint stripe 1306 being above the threshold temperature.

In some example embodiments, a person may visually inspect the thermochromic paint stripes 1302, 1304, 1306 and record the particular ones of the thermochromic paint stripes 1302, 1304, 1306 that have a color indicative of the level of the solid 120 in the cavity 104 of the container. By using the thermochromic paint stripes 1302, 1304, 1306, which are made from a thermochromic material, the level of the solid 120 in the cavity 104 of the container 102 can be visually and non-invasively estimated. For example, by estimating the level of the solid 120 in the cavity 104, maintenance operations such as removing at least a portion of the solid 120 may be performed before the solid 120 accumulates close to the fire tube 106. Also, unnecessary disruptions of normal operations of the horizontal fluid separator 1300 may be avoided if the level of the solid 120 is estimated to be low.

Although FIG. 1300 shows the thermochromic paint stripes 1302, 1304, 1306 on one side of the horizontal fluid separator 1300, the thermochromic paint stripes 1302, 1304, 1306 may extend to the opposite side of the container 102. In some alternative embodiments, the horizontal fluid separator 1300 may include one or more temperature strips than shown without departing from the scope of this disclosure. In some alternative embodiments, the horizontal fluid separator 1300 may include thermochromic paint stripes on the longitudinal side of the container 102 that is opposite from the longitudinal side of the container 102 where the thermochromic paint stripes 1302, 1304, 1306 are located. In some alternative embodiments, the horizontal fluid separator 1300 may include other components than shown without departing from the scope of this disclosure. In some alternative embodiments, the horizontal fluid separator 1300 may have a different shape than shown without departing from the scope of this disclosure. In some alternative embodiments, the thermochromic paint stripes 1302, 1304, 1306 may be at different locations than shown without departing from the scope of this disclosure. In some alternative embodiments, the thermochromic paint stripe 1306 may extend, elevation-wise, above the location of the fire tube 106 without departing from the scope of this disclosure. In some alternative embodiments, the thermochromic paint stripes 1302, 1304, 1306 may cover a smaller or larger area of the container 102 without departing from the scope of this disclosure. In some alternative embodiments, the horizontal fluid separator 1300 may include thermochromic paint stripes that extend elevation-wise upward instead of in addition to the thermochromic paint stripes 1302, 1304, 1306 that are horizontally stripes.

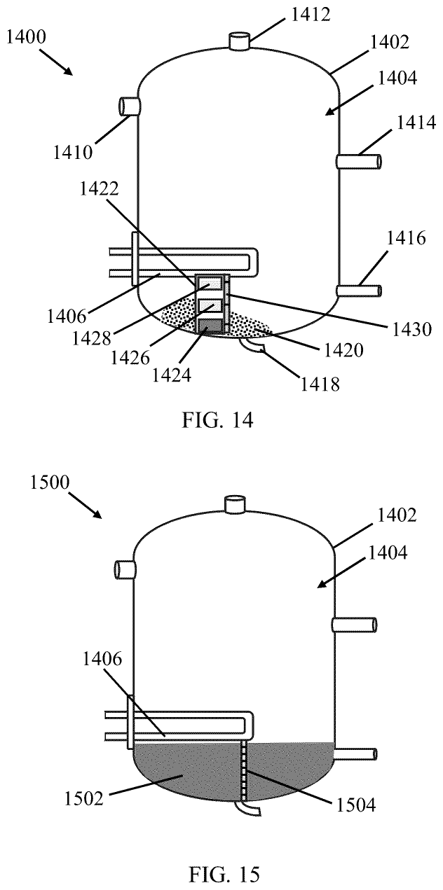

FIG. 14 illustrates a vertical fluid separator 1400 with a temperature strip 1422 for estimating solid level in the vertical fluid separator 1400 according to an example embodiment. In some example embodiments, the vertical fluid separator 1400 includes a container 1402 having a cavity 1404. In FIG. 14, the container 1402 is shown as transparent and some components of the separator 1400, such as a diverter plate, are omitted for clarity of illustration.

In some example embodiments, the container 1402 includes a fluid inlet 1410 and multiple outlets including a gas outlet 1412, an oil outlet 1414, and a water outlet 1416. A multiphase fluid (e.g., crude oil) may be provided into the cavity 104 via the fluid inlet 110. After separation of the multiphase fluid by the vertical fluid separator 1400, gas may exit the cavity 1404 through the gas outlet 1412, oil may exit the cavity 1404 through the oil outlet 1414, and water may exit the cavity 1404 through the water outlet 1416. The container 1402 may also include a solid drain 1418 for removing solid 1420, such as sand, paraffins, iron sulfide, rock, wax, and/or other material(s), from the cavity 1404 of the container 1402.

In some example embodiments, the vertical fluid separator 1400 includes a fire tube 1406 that extends into the cavity 1404 of the container 1402. For example, heat may be directed into the fire tube 1406, and the fire tube 1406 may dissipate the heat into the cavity 1404. The heat dissipated by the fire tube 1406 may help facilitate the separation of the multiphase fluid. To avoid damage to the fire tube 1406, the solid 1420 may be removed from the cavity 1404 before the solid 1420 accumulates and reaches the fire tube 1406, where the solid 1420 may interfere with the dissipation of heat by the fire tube 1406.

In some example embodiments, the vertical fluid separator 1400 includes a thermochromic indicator that is on the outside of the container. Thermochromic indicator may cover at least a portion of the container 1402. To illustrate, the temperature strip 1422 may be attached to the container 1402 on the outside of the container 1402, thereby covering a portion of the container 1402. The temperature strip 1422 may be attached to the container 1402 at a location corresponding to areas of the cavity 104 and inside surface of the container 1402 that are likely to have accumulation of the solid 1420. The temperature strip 1422 may be attached to the container 1402 magnetically or using an adhesive. The temperature strip 1422 may be at least partially located elevation-wise below the location of the fire tube 106 that is inside the cavity 104. For example, the temperature strip 1422 may extend upwards toward the fire tube 1406 from below.

In some example embodiments, the temperature strip 1422 may include thermochromic indicator elements 1424, 1426, 1428. For example, the temperature strip 1422 may be an instance of the temperature strip 602 of FIG. 6, where the thermochromic indicator elements 1424, 1426, 1428 correspond to the thermochromic indicator elements 604, 606, 608, respectively, of the temperature strip 602 of FIG. 6. To illustrate, each thermochromic indicator element of the thermochromic indicator elements 1424, 1426, 1428 may include a thermochromic material, such as a liquid crystal material, which can be formulated to have different colors corresponding to different ranges of temperatures in the manner described above with respect to the temperature strip 302 of FIG. 3. For example, the thermochromic indicator elements 1424, 1426, 1428 may each have a first color when exposed to a temperature or a range of temperatures below a threshold temperature (e.g., a threshold temperature of ninety degrees Fahrenheit) and a second color when exposed to a temperature or a range of temperatures above the threshold temperature. For example, the thermochromic indicator elements 1424, 1426, 1428 may be responsive to different temperature ranges in the same manner or differently with respect to each other. The threshold temperature may be in the range of fifty to one hundred fifty degrees Fahrenheit, for example, depending on the operating environment. As another example, the threshold temperature may be in the range of eighty to one hundred twenty degrees Fahrenheit.

In some example embodiments, areas of the container 1402 covered by the solid 1420 have a temperature below the threshold temperature, and areas of the container 1402 that are not covered by the solid 1420 may have a temperature above the threshold temperature. To illustrate, the level of the solid 1420 in the cavity 1404 may be such that the temperature of the container 1402 at the location of the thermochromic indicator element 1424 is below the threshold temperature and such that the temperature of the container 1402 at the locations of the thermochromic indicator elements 1426, 1428 is above the threshold temperature. As such, the thermochromic indicator element 1424 may have a color (e.g., a dark color or a light color) indicative of the temperature of the container 1402 at the thermochromic indicator element 1424 that is below the threshold temperature. Thus, the color of the thermochromic indicator element 1424 may indicate that the level of the solid 1420 in the cavity 1404 is aligned with or otherwise at least, elevation-wise, at the level of the location of thermochromic indicator element 1424.

In some example embodiments, the thermochromic indicator elements 1426, 1428 may have the same or similar color (e.g., a light color or a dark color) indicative of the temperature of the container 1402 at the locations of the thermochromic indicator elements 1426, 1428 being above the threshold temperature. Thus, the color of the thermochromic indicator elements 1426, 1428 may indicate that the level of the solid 1420 in the cavity 1404 is elevation-wise below the locations of the thermochromic indicator elements 1426, 1428. If the level of the solid 1420 increases, the color of one or both of the thermochromic indicator elements 1426, 1428 may change to indicate the level of the solid 1420. To be clear, the colors of the thermochromic indicator elements 1424, 1426, 1428 described or suggested herein are example colors, and the thermochromic indicator elements 1424, 1426, 1428 may have other colors without departing from the scope of this disclosure.

In some example embodiments, the temperature strip 1422 includes solid level markers 1430 corresponding to different vertical levels of the solid 1420 inside the cavity 1404. For example, the solid level markers 1430 may include numbers, letters, and/or symbols corresponding to different levels of the solid 1420 inside the cavity 1404. To illustrate, a person may visually inspect the temperature strip 1422 and record the solid level marker of the solid level markers 1430 that is, for example, associated with the highest one of the thermochromic indicator elements 1424, 1426, 1428 that has a color indicative of the level of the solid 1420 in the cavity 1404. In general, the temperature strip 1422 is attached to the container 1402 at a location corresponding to an area of the cavity 1404 and to the inside surface of the container 1402 where the solid 1420 is likely to accumulate.

By using the temperature strip 1422, which is made from a thermochromic material, the level of the solid 1420 in the cavity 1404 of the container 1402 can be visually and non-invasively estimated. For example, by estimating the level of the solid 1420 in the cavity 1404, maintenance operations such as removing at least a portion of the solid 1420 may be performed before the solid 1420 accumulates close to the fire tube 1406. Also, unnecessary disruptions of normal operations of the vertical fluid separator 1400 may be avoided if the level of the solid 1420 is estimated to be low.

In some alternative embodiments, the vertical fluid separator 1400 may include one or more temperature strips than shown without departing from the scope of this disclosure. In some alternative embodiments, the vertical fluid separator 1400 may include one or more temperature strips on the longitudinal side of the container 1402 that is opposite from the longitudinal side of the container 1402 where the temperature strip 1422 is located. In some alternative embodiments, the vertical fluid separator 1400 may include components other than shown without departing from the scope of this disclosure. In some alternative embodiments, the vertical fluid separator 1400 may have a different shape than shown without departing from the scope of this disclosure. In some alternative embodiments, the temperature strip 1422 may be at a different location than shown without departing from the scope of this disclosure. In some alternative embodiments, the temperature strip 1422 may extend, elevation-wise, above the location of the fire tube 1406 without departing from the scope of this disclosure. In some alternative embodiments, the solid level markers 1430 may be omitted without departing from the scope of this disclosure.

FIG. 15 illustrates a vertical fluid separator 1500 with thermochromic paint 1502 for estimating solid level in the vertical fluid separator 1500 according to another example embodiment. One or more portions of the thermochromic paint 1502 may change color responsive to the corresponding temperature of the container 1402 and thereby indicating the level of solid, such as sand, paraffins, iron sulfide, rock, wax, and/or other material(s), in the cavity 1404 in the manner described above with respect to the thermochromic paint 1202 and FIG. 11. A person may visually inspect the thermochromic paint 1502 and record the location of a boundary, if any, that separates different colors of the thermochromic paint 1502 as indicated by solid level markers 1504. In general, the thermochromic paint 1502 is painted on the outside surface of the container 1402 at locations corresponding to areas of the cavity 104 and to the inside surface of the container 1402 where solid is likely to accumulate.

In some example embodiments, a temperature of the container 1402 that is above a threshold temperature may be indicated by a first color of the thermochromic paint 1202 or a portion thereof, where the first color may be a relatively lighter color (e.g., red or yellow) or a relatively darker color (e.g., black). A temperature of the container 1402 that is below the threshold temperature may be indicated by a second color of the thermochromic paint 1202 or a portion thereof, where the second color is different from the first color and can be visually distinguishable from the first color. The threshold temperature may be in the range of fifty to one hundred fifty degrees Fahrenheit, for example, depending on the operating environment. As another example, the threshold temperature may be in the range of eighty to one hundred twenty degrees Fahrenheit.

By using the thermochromic paint 1502, which is made from a thermochromic material, the level of solid in the cavity 1404 of the container 1402 can be visually and non-invasively estimated. For example, by estimating the level of solid in the cavity 1404, maintenance operations such as removing at least a portion of the solid 1420 may be performed before the solid accumulates close to the fire tube 1406. Also, unnecessary disruptions of normal operations of the vertical fluid separator 1500 may be avoided if the level of solid is estimated to be low.

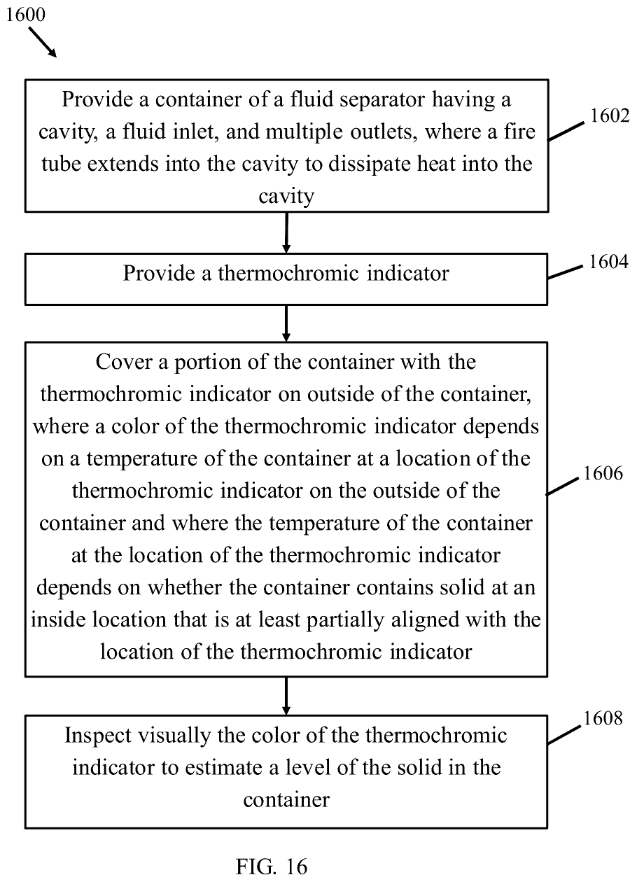

FIG. 16 illustrates method 1600 for non-invasively estimating solid level in a fluid separator according to an example embodiment. Referring to FIGS. 1A-13, in some example embodiments, at step 1602, the method 1600 includes providing a container of a fluid separator having a cavity, a fluid inlet, and multiple outlets, where a fire tube extends into the cavity to dissipate heat into the cavity. For example, the container 102 or the container 1402 may be provided. At step 1604, the method 1600 may include providing a thermochromic indicator. For example, one or more of the thermochromic strips 122, 202, 302, 402, 602, 902 may be provided. As another example, the thermochromic paint 1002, 1202 or the thermochromic paint stripes 1302, 1304, 1306 may be provided.

In some example embodiments, the step 1606, the method 1600 includes covering a portion of the container with the thermochromic indicator on outside of the container. For example, one or more of the thermochromic strips 122, 202, 302, 402, 602, 902 may be attached to the container 102 or the container 1402 on the outside surface of the particular container. As another example, the thermochromic paints 1002, 1202 or the thermochromic paint stripes 1302, 1304, 1306 may be painted on the outside surface of the container 102 or the container 1402. As described above, the color of the thermochromic indicator depends on a temperature of the container at a location of the thermochromic indicator on the outside of the container. The temperature of the container at the location of the thermochromic indicator depends on whether the container contains solid at an inside location that is at least partially aligned with the location of the thermochromic indicator. The color of the thermochromic indicator may be a first color if the temperature of the container at the location of the thermochromic indicator is below a threshold temperature, and the color of the thermochromic indicator may be a second color that is different from the first color if the temperature of the container at the location of the thermochromic indicator is above the threshold temperature.

In some example embodiments, at step 1608, the method 1600 may include visually inspecting the color of the thermochromic. For example, a person may visually determine the colors of the thermochromic strips 122, 202, 302, 402, 602, 902, the thermochromic paints 1002, 1202, and the thermochromic paint stripes 1302, 1304, 1306 to estimate the level of the solid, such as the solid 120, in the cavity (e.g., the cavity 104 of the container 102 or the cavity 1404 of the container 1402). Alternatively, the colors of the thermochromic strips 122, 202, 302, 402, 602, 902, the thermochromic paints 1002, 1202, and the thermochromic paint stripes 1302, 1304, 1306 can be inspected using a camera remotely or a computer vision that can evaluate the colors to estimate the level of the solid, such as the solid 120, in the cavity, such as the cavity 104 of the container 102.

In some alternative embodiments, the method 1600 may include more or fewer steps than shown in FIG. 16 without departing from the scope of this disclosure. In some alternative embodiments, some of the steps of the method 1600 may be performed in a different order than described without departing from the scope of this disclosure.

Although some embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

While particular embodiments are described above, it will be understood it is not intended to limit the invention to these particular embodiments. On the contrary, the invention includes alternatives, modifications and equivalents that are within the scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, and components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A fluid separator with solid level indicator, the fluid separator comprising:
a container having a cavity, wherein the container comprises a fluid inlet and multiple fluid outlets;
a fire tube extending into the cavity to dissipate heat into the cavity; and
a thermochromic indicator that is on the outside of the container, wherein the thermochromic indicator covers at least a portion of the container, wherein a color of the thermochromic indicator depends on a temperature of the container at a location of the thermochromic indicator on the outside of the container, and wherein the temperature of the container at the location of the thermochromic indicator depends on whether the container contains a solid at an inside location that is at least partially aligned with the location of the thermochromic indicator.

2. The fluid separator of claim 1, wherein the color of the thermochromic indicator is a first color if the temperature of the container at the location of the thermochromic indicator is below a threshold temperature and wherein the color of the thermochromic indicator is a second color that is different from the first color if the temperature of the container at the location of the thermochromic indicator is above the threshold temperature.

3. The fluid separator of claim 2, wherein the threshold temperature is in a range of fifty degrees Fahrenheit to one hundred fifty degrees Fahrenheit.

4. The fluid separator of claim 2, wherein the thermochromic indicator includes a temperature strip that is attached to the container on the outside of the container.

5. The fluid separator of claim 4, wherein the temperature strip includes solid level markers corresponding to different vertical levels of solid inside the cavity.

6. The fluid separator of claim 4, wherein different portions of the temperature strip 122 that are in contact with different areas of the container 102 have different colors from each other.

7. The fluid separator of claim 4, wherein the temperature strip is attached to the container magnetically or by an adhesive.

8. The fluid separator of claim 4, wherein the temperature strip is at least partially located elevation-wise below a location of the fire tube inside the cavity.

9. The fluid separator of claim 4, wherein the temperature strip extends upwards toward the fire tube elevation-wise from below the fire tube.

10. The fluid separator of claim 4, wherein the temperature strip extends horizontally for at least a portion of a horizontal length of the container.

11. The fluid separator of claim 4, further comprising a second thermochromic indicator that includes a second temperature strip attached to the container on the outside of the container.

12. The fluid separator of claim 11, wherein the second temperature strip includes multiple thermochromic indicator elements, wherein a first thermochromic indicator element of the multiple thermochromic indicator elements has the first color if a temperature of the container at a location of the first thermochromic indicator element is below the threshold temperature and the second color if the temperature of the container at the location of the first thermochromic indicator element is above the threshold temperature.

13. The fluid separator of claim 1, wherein the thermochromic indicator includes a thermochromic paint that covers the portion of the container on the outside of the container.

14. The fluid separator of claim 13, wherein the portion of the container is at least partially elevation-wise below a vertical location of the fire tube inside the cavity.

15. The fluid separator of claim 1, wherein the fluid separator is a horizontal fluid separator.

16. The fluid separator of claim 1, wherein the fluid separator is a vertical fluid separator.

17. A method for non-invasively estimating solid level in a fluid separator, the method comprising:
providing a container of a fluid separator having a cavity, a fluid inlet, and multiple outlets, wherein a fire tube extends into the cavity to dissipate heat into the cavity;
providing a thermochromic indicator;
covering a portion of the container with the thermochromic indicator on outside of the container, wherein a color of the thermochromic indicator depends on a temperature of the container at a location of the thermochromic indicator on the outside of the container and wherein the temperature of the container at the location of the thermochromic indicator depends on whether the container contains solid at an inside location that is at least partially aligned with the location of the thermochromic indicator; and
inspecting visually the color of the thermochromic indicator to estimate a level of the solid in the container.

18. The method of claim 17, wherein the color of the thermochromic indicator is a first color if the temperature of the container at the location of the thermochromic indicator is below a threshold temperature and wherein the color of the thermochromic indicator is a second color that is different from the first color if the temperature of the container at the location of the thermochromic indicator is above the threshold temperature.

19. The method of claim 17, wherein the thermochromic indicator includes a temperature strip that is attached to the container on the outside of the container.

20. The method of claim 17, wherein the thermochromic indicator includes a thermochromic paint.
